(19) United States
(12) Patent Application Publication
(10) Pub. No.: US 2008/0169960 A1
(43) Pub. Date: Jul. 17, 2008

(54) Handheld System for Radar Detection

(76) Inventor: Erwin T. Rosenbury, Castro Valley, CA (US)

Correspondence Address: WHITE-WELKER & WELKER, LLC, P.O. BOX 199, CLEAR SPRING, MD, 21722-0199, US

(21) Appl. No.: 11/554,578

(22) Filed: Oct. 30, 2006

(51) Int. Cl. G01S 13/62

(52) U.S. Cl. 342/27; 342/28; 342/175; 342/114; 342/58

(57) ABSTRACT

The present invention is a radar platform that detects intruders and wirelessly reports to a key-fob. The entire radar platform is water-resistant and two banks of batteries are included for convenience or extended operation time. The device consists of a MicroPower Radar (MPR), a data acquisition (DAQ) element and a processor. Radar sends a short, low-amplitude signal of radio-frequency (RF) energy toward the target. This signal reflects from the target and is received as a Doppler change in signal amplitude. The radar's RF energy is in the radio frequency band and operates at much lower powers than many mobile devices such as cell phones. This Doppler System change in signal amplitude is filtered, amplified and presented to the DAQ. The DAQ converts the analog Doppler signal into a digital bit-stream and passed to the radar processor. Proprietary software analysis is performed to further filter and to make an alarm determination.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to radar systems. More specifically, the present invention relates to a wireless portable handheld radar detection system.

### BACKGROUND OF THE INVENTION

Various devices known in the prior art have been devised that utilize radar to detect objects. One shortcoming of such devices is that either in military or civilian use they are not constructed in such a manner that permits them to be handheld, portable, and rugged enough to withstand various environmental conditions such as wind, rain, and sand.

Another shortcoming inherent with prior art devices are that, when designed to be portable, they are not equipped with remote means for one or more uses to which a detection signal or other information can be transmitted. It is therefore a desirable feature to have a remote device that can communicate with the radar unit that is small, lightweight, and provides control means.

Another well-known problem in the prior art is that similar portable devices known in the prior art are battery powered which often means that they have a limited operating time period and need recharged on a daily basis. A device that provides for additional run time, via an alternative or additional power source is needed.

### SUMMARY OF THE INVENTION

The present invention is a radar platform detects intruders and wirelessly reports to a key-fob. The entire radar platform is particularly water-resistant when in its shipping configuration and two banks of batteries are included for convenience or extended operation time. With the radar antenna in place, the platform is water resistant and will withstand rain, but not submersion.

It is an object of the present invention to provide a portable radar detection system with mutliple battery banks and operational states. Should the operator forget to replace one bank, the second can act as a backup or if a two-night operation is anticipated, the system may be operated for two nights by simply switching banks the second night.

The present invention is designed as a personal handheld radar detection device and consists of a MicroPower Radar (MPR), a data acquisition (DAQ) element and a processor. Radar sends a short, low-amplitude signal of radio-frequency (RF) energy toward the target. This signal reflects from the target and is received as a Doppler change in signal amplitude. The radar's RF energy is in the radio frequency band and operates at much lower powers than many mobile devices such as cell phones. RF has the advantages of penetrating foliage while operating at one-tenth the power of a cellular or cordless phone. This Doppler System change in signal amplitude is filtered, amplified and presented to the DAQ. The DAQ converts the analog Doppler signal into a digital bit-stream and passed to the radar processor.

Proprietary software analysis is performed to further filter and to make an alarm determination. The radar is intended to be mounted near the top of a TIMS device. The antenna may penetrate through the top of the TIMS device and should be mounted away from other antennas and as far from the edge of the device as practical.

The present invention teaches a radar detection system that provides high reliability, low false alarm personnel detection through out a 160′ precision detection zone. The system is small in size, operates all night on standard alkaline batteries (D-cells), provides an alarm indicator to a wireless key-fob in addition to other audible and visual indicators.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a perspective view of one embodiment of the radar system of the present invention;

FIGS. 2a-c illustrates the three-element antenna stack of the present invention;

FIG. 3 illustrates the key fob of the present invention;

FIG. 4 is another perspective view of one embodiment of the present illustrating the two batter pack options and the battery monitoring display;

FIG. 5 is a block diagram of the TIMS system of the present invention;

FIG. 6 is an illustration of the coverage area of the present invention;

FIGS. 7a-d are perspective view of the radar of the present invention; and

FIG. 8 illustrates the operational range of one embodiment of the present invention.

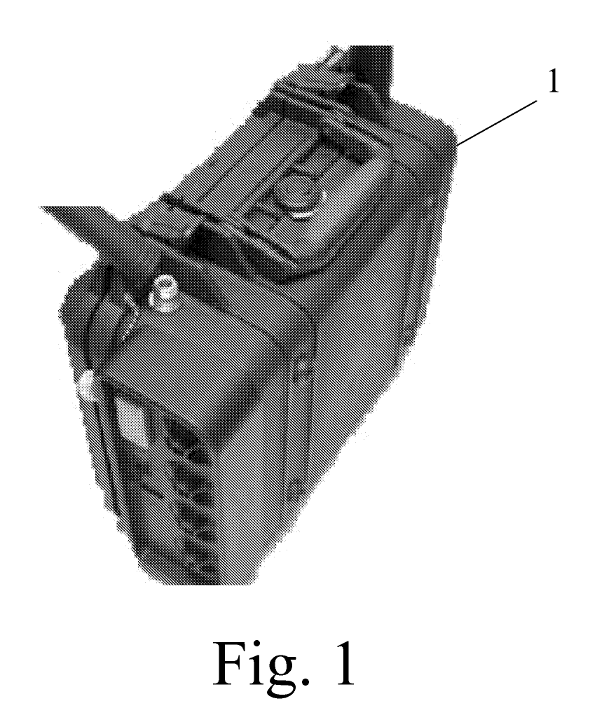

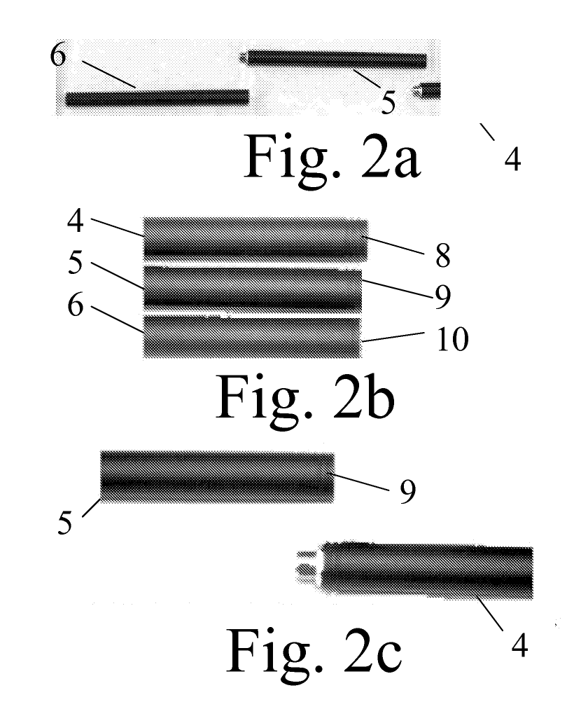

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, functional, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

### J-wire System Embodiment

Now referring to the Figures, the J-wire system embodiment of the present invention consists of two primary elements, the Radar Platform 1 and the Key-fob 2. The Key-fob 2 requires no assembly, but does contain one AAA standard alkaline battery that could be purchased at any store that sells batteries.

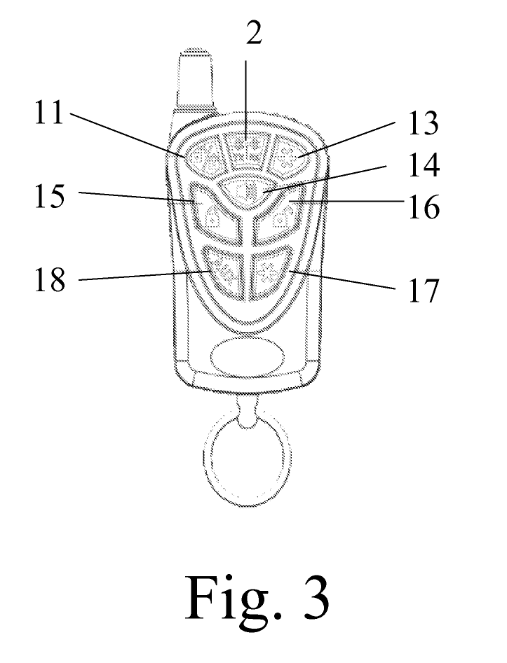

The Radar-Platform 1 contains a three-piece antenna 3 as illustrated in FIGS. 3a-c that must be assembled in the proper order for operation. The three antenna elements 4, 5, & 6 may be found inside the front cover 7 of the Radar Platform 1. A series of indented lines 8, 9, 10 are printed around each end of each element 4, 5, & 6. Starting with the three-indentation-end 4, the connectors 4, 5, & 6 are threaded together being careful not to cross-thread the connectors 4, 5, & 6 and being careful not to over-tighten them as well. The connectors 4, 5, & 6 should be tightened with two fingers and a thumb and not with the palm of the hand. The assembler will notice that the top of element 5 has two-indented lines 9 printed on the top end. Next, select the element 5 with two-indented lines 9 printed on it and mate it to the bottom of element 8. Finally, the top element 6 has one-indented line 10 printed on it to match the middle of element 5 already mounted. Thread the top element 6 onto the middle element 5.

Now referring to FIG. 3, J-Wire functions are controlled through the remote control key-fob 2. Indicators and Controls include Arm/Disarm 11 (Orange); Transmit/Receive 12 (Green); Auxiliary 13 (Yellow); Alarm/Siren 14 (Red); Arm Button 15; Disarm Button 16; Panic Button 17; and an Auxiliary Button 18.

The J-Wire remote control key-fob 2 operates on a single standard AAA alkaline battery. Should the key-fob battery run low, it will emit two long beeps five seconds after each transmission, repeating three times every 25 seconds signaling that the battery needs replacement. Battery replacement is accomplished by gently pulling the battery cover away from the key fob 2. Once batter replacement has occurred, all icons will light and all tones will sound (a melody) as a test of all indicators.

The arm button 15 turns on the radar and enables alarm transmissions to the key-fob 2. By pressing the button for one second, a green transmit light will flash during transmission. Upon receipt of the command, the radar-cone returns a confirmation with a single beep and the Orange LED will flash three times.

The disarm button 16 turns off the radar and disables alarm transmissions to the key-fob 2. By pressing the button for one second, a green transmit light will flash during transmission. Upon receipt of the command, the radar-cone returns a confirmation of four beeps and an Orange LED will flash six times and a red LED will illuminate for three seconds.

The Auxiliary button 18 enables a silent mode via a short press (<1 sec) before pressing the Arm button or can confirm the link between key-fob 2 and radar cone 1 via a long press (>1.5 sec). Finally, a long press (>2 sec) on the panic button 17 enables a paging function.

When an alarm is detected, the radar cone 1 sends a signal to the key fob 2 and ten beeps with six red LED flashes. The alarm will repeat every 100 seconds until confirmed. Clearing the alarm is accomplished by pressing any button on the key-fob 2. Commands are disabled while the alarm is active (and the green LED will remain off). The clearing operation will not send a command. Pressing a command button after acknowledging an alarm will send a command.

If the radar-cone 2 receives multiple or continuous alarms, it will hold-off re-reporting alarms until there are thirty continuous seconds without alarm. This becomes important during operational test.

If the key-fob 2 is out of range, commands will not be acknowledged by a page and a warning is sent. Three quick beeps will be repeated twice and the Green LED will flash six times. Moving the key-fob 2 closer to the radar cone 1 and reconfirming with the Auxiliary command button 18 is required to reset the system.

i-Wire Radar Platform

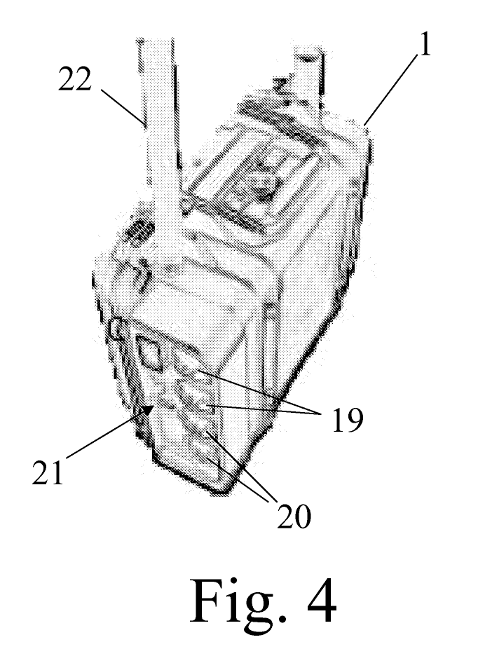

The radar platform 1 detects intruders and wirelessly reports to the key-fob 2. Operation is accomplished by turning the switch 21 to either battery bank A 19 or battery bank B 20 as illustrated in FIG. 4. Two banks of batteries 19 & 20 are included for the convenience of the operator. Should the operator forget to replace one bank, the second can act as a backup or if a two-night operation is anticipated, the system may be operated for two nights by simply switching banks the second night.

The entire radar platform 1 is particularly water-resistant when in its shipping configuration. With the radar antenna 22 in place, the platform 1 is water resistant. The antenna 22 will withstand rain, but not submersion. There is a battery monitor meter located near the on-off switch. It monitors the active battery bank. A new battery pack should read between 14 V and 16 V. The system will start to false alarm (another indication of low battery power) at or just below 10 V. Batteries should be changed as a pack of ten. In other words, if battery bank A 19 reads 11 V at the start of a shift, all ten batteries in bank A should be replaced with fresh batteries. A new set of batteries should last 16 hours or more depending on the number of alarms and the ambient temperature.

Before the Operation Test can be undertaken, the radar-cone 1 must be fully charged before a night of operation. First, the radar cone 1 must be placed in position. Next the radar cone 1 is turned on. The operator then moves outside the detection zone (>100 ft) and use the key-fob 2 to arm the radar-cone 1. Once the radar cone 1 is armed, the operator must wait approximately 35 seconds to talk into the radar-cone detection zone (<70 ft) to test the device. Upon entry into the detection zone the operator should acknowledge the alarm on the key-fob 2 by pressing the Aux button 18 one time. Finally, the operator should secure the area for the evening and acknowledge any remaining alarms.

The system of the present invention consists of a MicroPower Radar (MPR), a data acquisition (DAQ) element and an encrypted radio link. The Radar sends a short, low-amplitude signal of radio-frequency (RF) energy toward the perimeter. This signal reflects from moving targets and is received as a Doppler change. The radar's RF energy is in the UHF band and operates at low power. This Doppler change in signal amplitude is filtered, amplified and presented to the DAQ. The DAQ converts the analog Doppler signal into a digital bit-stream and passed to the processor. Proprietary software analysis is performed to further filter and to make an alarm determination. The radar and radio are located in the Platform case 1.

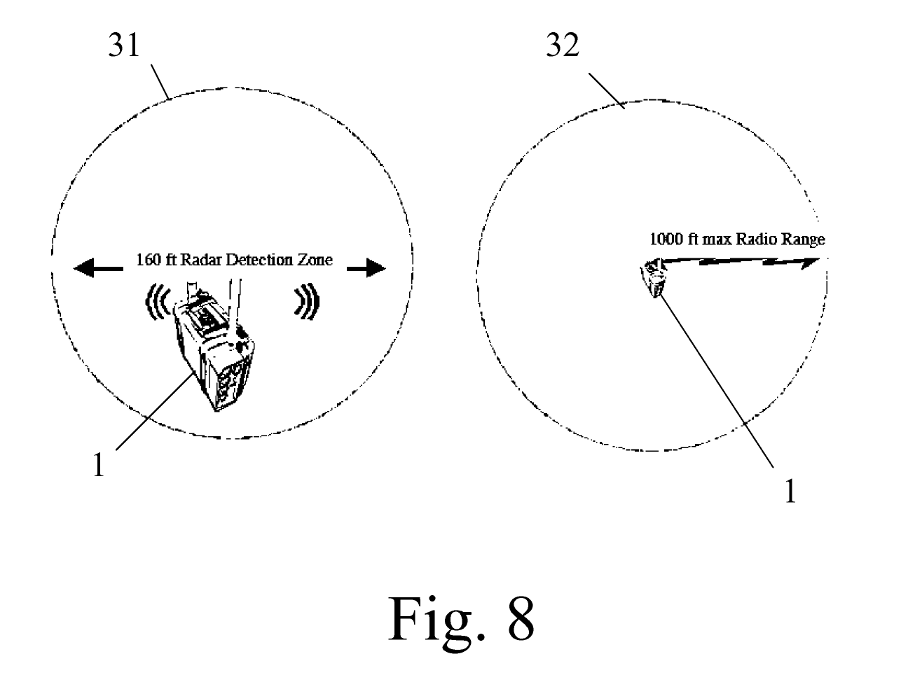

The primary system elements include the radio, a data acquisition element and the radar itself. The radar is the key technological breakthrough that enables J-Wire operation. The radar is a pulse Doppler design with MTI (moving target indicator). The radar thereby creates a zone or bubble of detection. Any motion within the bubble results in an analog signal reported at the output of the radar as illustrated in FIG. 8. The system of the present invention has a 160 ft Radar Detection Zone 31 and 1000 ft max Radio Range 32.

Radar system performance depends largely on maximizing the signal while minimizing the noise. Signal is strictly determined by the radar power output convolved with the movement of the target. Noise, on the other hand, is a function of many factors. Some potential noise sources are undesired motion such as operator motion or the motion of a nearby system (e.g. motion of the aircraft) as moving objects will only be detected within the detection zone and fluorescent lighting which produces a strong motion signal to the radar as the plasma within the fluorescent light actually moves at 120 times per second and may yield false Alarm indications.

Additionally, nearby electronics may generate radio frequency noise that couples into the radar as a noise signal. This is the one case where the noise source may be found outside the detection zone. For example, a cellular phone within three feet may interfere with the operation of the radar. Other radios may also interfere and depending on power output and frequency coupling, may interfere at greater distances from the sensor and may yield false Alarm indications. Finally, the radar includes a very large gain amplifier stage and is sensitive to rapid temperature fluctuations and may yield false Alarm indications.

In all four cases, false alarm indications are possible. In no case should a false No-alarm indication be caused by noise. Great care has been taken to ensure that J-Wire errs on the side of false Alarm indication and that false No-Alarm indications are statistically as close to non-existent as possible.

All receivers have a noise floor, below which signals are too low to measure. This noise floor is primarily determined by the quality of the RF amplifier which is fairly standardized in today's IC's and the bandwidth of the received signal.

Several features of the radar mitigate but do not eliminate noise signals. The first is a narrow filter that attenuates frequencies above five hertz by a factor of twelve dB per octave. This greatly reduces unwanted signals from fluorescent lighting as well as fans and other motor driven noise. It also reduces broadband electronic noise that may be modeled as Gaussian noise in the narrow (near baseband) passband of interest. The filter has a passband of 0.3 Hz to 100 Hz. This passband was chosen because the fastest expected target should be 20 mph and the slowest target could be a crawling target. The 0.3 to 100 Hz passband covers these extremes with a margin of safety. The narrow passband also optimizes receiver noise to its lowest level.

The second key feature of the present invention is the range gate of the radar. Motion sources outside the range gate are attenuated. Signal processing is also utilized to mitigate noise as described below. Once the signal is converted to digital, the software processes the results as follows.

### J-Wire RW-TIMS-100 Embodiment for Government Applications

In this embodiment the radar contains sensitive circuitry, therefore board movement must be eliminated, and nearby active circuitry may induce noise into the radar unless shielded. There are no user adjustments other than those described above—adjusting potentiometers other than those described above will result in improper operation. This embodiment of the present invention improves on the prior art by providing a high reliability, low false alarm motion detection system with very low radar power consumption of approximately 300 milliamps contained within a small, light, low profile package that requires autonomous operation with no user adjustment required. Dual range gates at 13 and 65 m with Passbands of 0.03 to 5 Hz for detection of slow walking to fast running targets and a Passband of 0.03 to 5 Hz for detection of slow walking to fast running targets.

Now referring to FIG. 4, in this embodiment the system consists of a MicroPower Radar (MPR) 26, a data acquisition (DAQ) element 24 and a processor 25. The MicroPower Radar 26 sends a short, low-amplitude signal of radio-frequency (RF) energy 27 toward the target 28. This signal reflects from the target and is received as a Doppler change in signal amplitude. The radar's RF energy 27 is in the radio frequency band and operates at much lower powers than many mobile devices such as cell phones. RF has the advantages of penetrating foliage while operating at one-tenth the power of a cellular or cordless phone.

The Doppler change in signal amplitude is filtered, amplified and presented to the DAQ 24. The DAQ 24 converts the analog Doppler signal into a digital bit-stream and passed to the Radar's processor 25. Proprietary software analysis is performed to further filter and to make an alarm determination. The software is embedded on an Atmel Atmega 128. The software is permanently burned-into the processor 25 and there are no user functions and no maintenance is required.

The radar 26 is intended to be mounted near the top of a TIMS device. The antenna may penetrate through the top of the TIMS device and antenna should be mounted away from other antennas and as far from the edge of the device as practical. The TIMS Radar is intended to operate from the top of the TIMS device with the TIMS device placed on the ground or at a higher elevation.

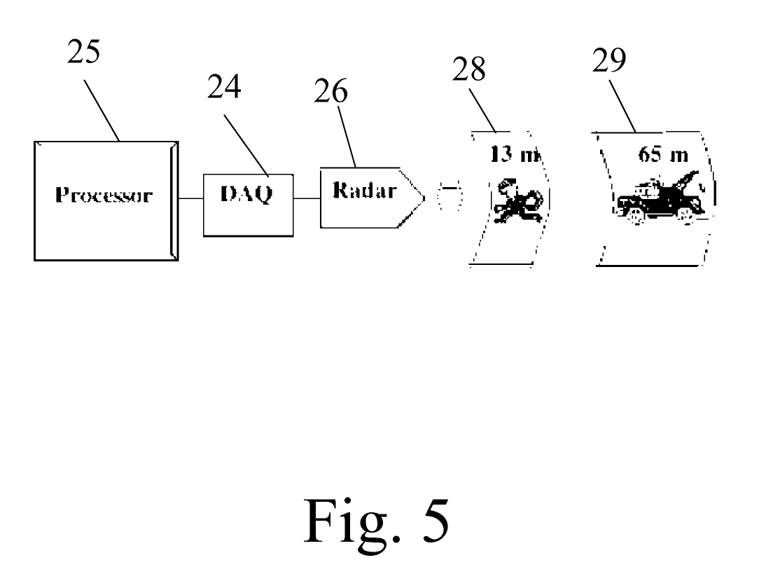

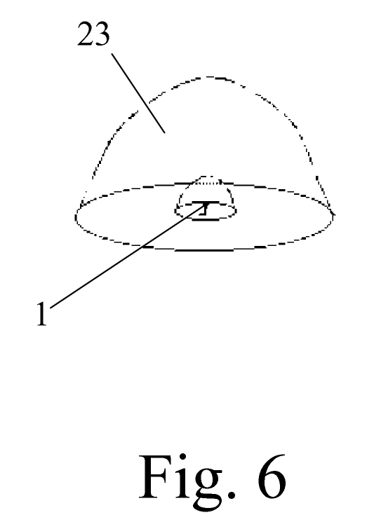

The primary system elements include the processor 25, a data acquisition element 24 and the radar 26 itself. The radar 26 is the key technological breakthrough that enables 65 m operation 29. The radar 26 is a pulse Doppler design with MTI (moving target indicator). The radar 26 thereby creates a zone or bubble of detection 23 as illustrated in FIG. 5. Any motion within the bubble 23 results in an analog signal reported at the output of the radar 26.

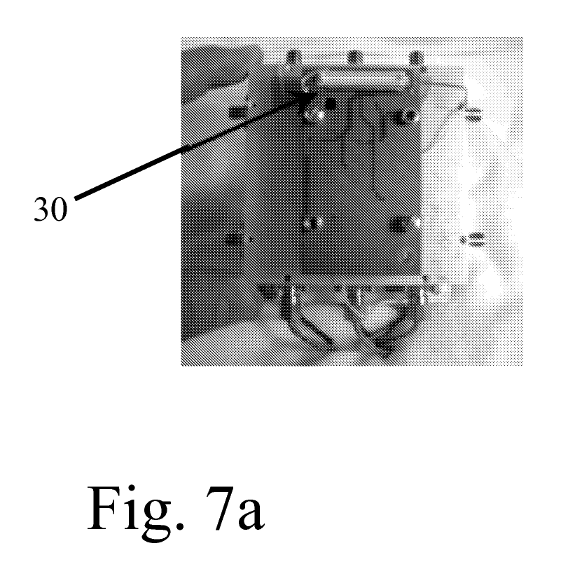

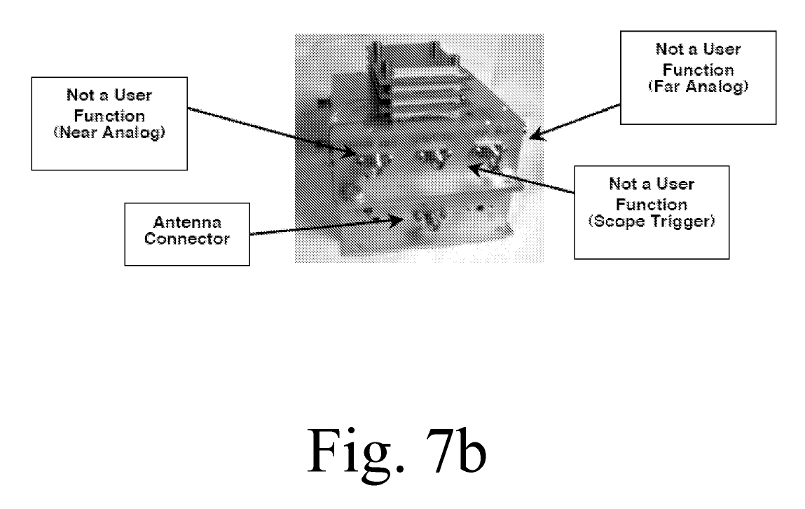

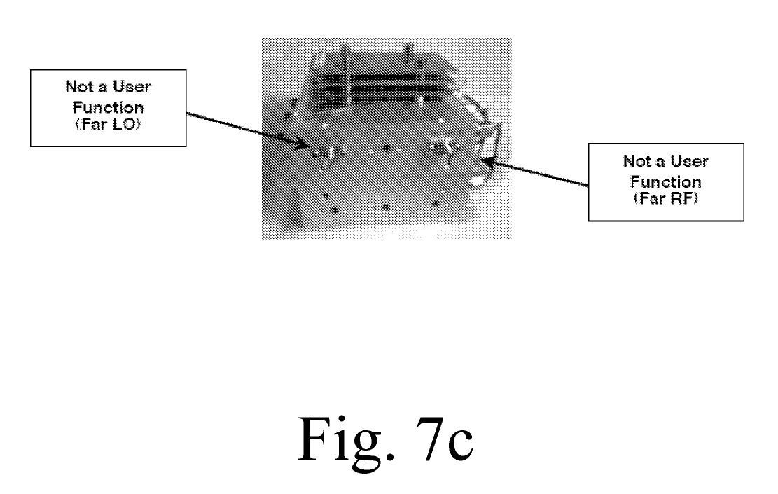

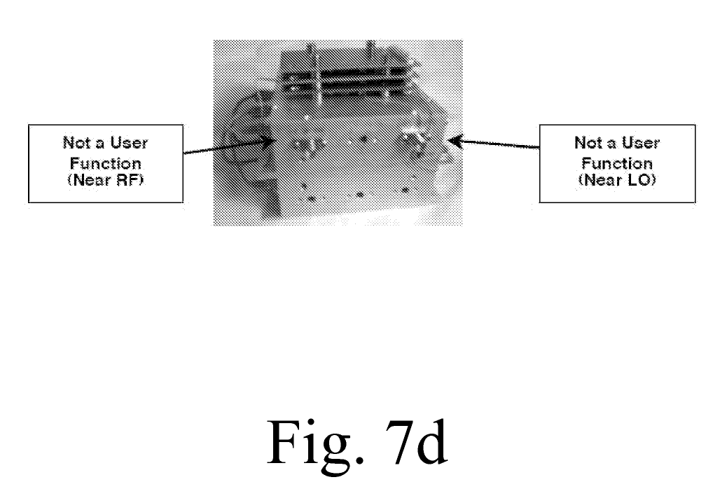

Now referring to FIGS. 7a-d, perspective views of the radar are illustrated showing a plurality of sides and connectors. Referring to FIG. 7a, a user interface is provided through a Hirose connector 30. Now referring to FIG. 7b the antenna connector 31, two analog connectors 32 & 33 and a scope trigger 34 not for user functions are illustrated. FIGS. 7c and 7d also illustrate two other sides of the radar that contain multiple RF connections that are not for user functions.

Several features of the radar embodiment mitigate but do not eliminate noise signals. The first is a narrow filter that attenuates frequencies outside the passband by a factor of twelve dB per octave. This greatly reduces unwanted signals from fluorescent lighting as well as fans and other motor driven noise. It also somewhat reduces broadband electronic noise that may be modeled as Gaussian noise in the narrow (near baseband) passband of interest. The filter has a passband of 0.1 Hz to 7 Hz. This passband was chosen to include walking targets 0.1 to 5 km/hr. The 0.1 Hz to 7 Hz passband covers these extremes with a margin of safety. The narrow passband also optimizes receiver noise to its lowest level.

The second key feature is the range gate of the radar. Motion sources outside the range gate are attenuated. Signal processing is also utilized to mitigate noise. Once the signal is converted to digital, the software processes the results as follows. A Fourier analysis is performed to convert the time series into a frequency representation. It's still the same signal, simply broken down into its frequency components. By this method the signals show-up in their respective frequency “bins.” The expected heart rate bins may then be compared to noise bins and a threshold set. The longer the measurement, the more accurate the result, therefore an indication may occur within milliseconds. Signal processing may also include dynamic thresholding to allow the radar to better adapt to various noise environments.

A set of diagnostic software is included which displays the raw radar output signal and can be used to determine when there are problems and what they might be.

The radar sensor requires a single, regulated 3.3 V power source capable of providing 500 mA. It is critical that the power supply voltage does not exceed 3.32V (3.22±0.1V) or damage may result to the sensitive circuitry, therefore the radar should be handled with great care. There are no user adjustments other than those described above—adjusting potentiometers other than those described above will result in improper operation. For typical performance sensitivity is set at 1.2 mV/cm2@1 Hz, Doppler Passband (near) 0.1-7 Hz, Doppler Passband (far) 7-160 Hz, Dynamic Range 113 dB, and Voltage (PDA batt.) 3.6V at a Current of 18 mA.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.
The embodiments of the invention in which an exclusive property or privilege is claimed are defined as follows:

1. A radar detection system consisting of:
a water resistant case;
said case enclosing a first and a second battery bank, processor, a data acquisition element, a MicroPower radar, and an encrypted radio link wherein
the micropower radar emits a short, low-amplitude signal of radio-frequency energy in the UHF band,
said signal reflects from moving targets and is received as a Doppler change in signal amplitude that is filtered, amplified and presented to the data acquisition element;
said data acquisition element converts the analog Doppler signal into a digital bit-stream and passed to the processor;
software analysis is performed to further filter and to make an alarm determination;
an external switch on the case for selecting the desired battery bank;
an external battery monitor meter located near the on-off switch on the case;
a water resistant antenna
a three-piece antenna comprised of three antenna elements;
a remote Key-fob.

2. The radar detection device of claim one wherein
the three-piece antenna is disassembled and stored inside the front cover of the Radar Platform;
each antenna element is further comprised of a series of indented lines printed around each end of each element and male and female threads for connection;
a first antenna element consists of a one indentation female threaded end;
a second antenna element consists of a one indentation male threaded end and a two indentation female threaded end;
a third antenna element consists of a two indentation male threaded end and a three indentation female threaded end;
the antenna elements are threaded together in such a manner that the one indentation female threaded end of first antenna element is threaded to the one indentation male threaded end of the second antenna element and the two indentation female threaded end of the second antenna element is threaded to the two indentation male threaded end of the third antenna element, and the three indentation female threaded end of the third antenna element can be threaded to the radar case.

3. The radar detection device of claim 1 wherein the key-fob indicators and controls includes Arm/Disarm button and orange lighting means; Transmit/Receive button and green lighting means; Auxiliary button and yellow lighting means; Alarm/Siren button and Red lighting means; an Arm Button; a Disarm Button; a Panic Button; and an Auxiliary Button.

4. The radar detection device of claim 3 wherein
the arm button turns on the radar and enables alarm transmissions to the key-fob by pressing the button for one second, a green transmit light will flash during transmission and upon receipt of the command, the radar returns a confirmation with a single beep and the orange light will flash three times;
the disarm button turns off the radar and disables alarm transmissions to the key-fob by pressing the button for one second, a green transmit light will flash during transmission and upon receipt of the command, the radar returns a confirmation of four beeps and an orange light will flash six times and a red light will illuminate for three seconds;
the Auxiliary button enables a silent mode via a short press of a duration less than 1 second before pressing the Arm button or can confirm the link between key-fob and radar via a long press of a duration longer than 1.5 seconds; and
a long press of a duration longer than 2 seconds on the panic button enables a paging function.

5. The radar detection device of claim 3 wherein
when an alarm is detected, the radar sends a signal to the key fob and ten beeps with six red LED flashes;
the alarm will repeat every 100 seconds until confirmed;
clearing the alarm is accomplished by pressing any button on the key-fob;
commands are disabled while the alarm is active and the green light remain off;
he clearing operation will not send a command;
pressing a command button after acknowledging an alarm will send a command; and
if the radar receives multiple or continuous alarms, it will hold-off re-reporting alarms until there are thirty continuous seconds without alarm.

6. The radar detection device of claim 3 wherein
the remote control key-fob operates on a single standard AAA alkaline battery;
when the key-fob battery run low, the key fob will emit two long beeps five seconds after each transmission, repeating three times every 25 seconds signaling that the battery needs replacement;
once batter replacement has occurred, all icons will light and all tones will sound as a test of all indicators;
if the key-fob is out of range, commands will not be acknowledged by a page and a warning is sent form the radar to the key fob and three quick beeps will be repeated twice and the light will flash six times;
moving the key-fob closer to the radar and reconfirming with the Auxiliary command button resets the system.

7. The radar detection device of claim 1 wherein the radar is a pulse Doppler design with moving target indicator which creates a zone or bubble of detection in such a manner that any motion within the bubble results in an analog signal reported at the output of the radar.

8. The radar detection device of claim 1 wherein the radar has a 160 ft Radar Detection Zone and the radio has a 1000 ft max Radio Range.

9. The radar detection device of claim 1 wherein the radar further consists of a narrow filter that attenuates frequencies above five hertz by a factor of twelve dB per octave reduces unwanted signals and said filter has a passband of 0.3 Hz to 100 Hz.

10. The radar detection device of claim 9 wherein motion sources outside a range gate on the radar are attenuated and signal processing is utilized to mitigate noise.

11. A radar system consisting of
a case enclosing a MicroPower Radar, a data acquisition element and a processor wherein
the MicroPower Radar sends a short, low-amplitude signal of radio-frequency energy toward a target that is reflected from the target and received as a Doppler change in signal amplitude;
the received Doppler change in signal amplitude is filtered, amplified and presented to the data acquisition element which converts the analog Doppler signal into a digital bit-stream that is passed to the processor;
software analysis is performed to further filter and to make an alarm determination; and
providing a user interface through a Hirose connector located on an external surface of the case.

12. The radar system of claim 11 mounted near the top of another device such that the antenna penetrates through the top of the device and antenna is mounted away from other antennas on the top edge of the device.

13. The radar system of claim 11 wherein the radar enables 65 m operation and is a pulse Doppler design with moving target indicator and creates a bubble of detection so that any motion within the bubble results in an analog signal reported at the output of the radar.

14. The radar system of claim 11 further comprising dual range gates at 13 and 65 m with Passbands of 0.03 to 5 Hz for detection of slow walking to fast running targets and a Passband of 0.03 to 5 Hz for detection of slow walking to fast running targets.

15. The radar system of claim 14 further comprising a narrow filter that
attenuates frequencies outside the passband by a factor of twelve dB per octave;
reduces broadband electronic noise which is modeled as Gaussian noise in the narrow, near baseband, passband of interest; and
has a passband of 0.1 Hz to 7 Hz.

16. The radar system of claim 15 wherein
motions sources outside the range gate are attenuated; and
signal processing is utilized to mitigate noise such where the signal is converted from analog to digital and a software processes analyses the signal to produce a result.

17. The radar system of claim 16 wherein
a Fourier analysis is performed to convert a time series signal into a frequency representation, which breaks the signal down into its frequency components;
the signals are sorted by their frequency components into their respective frequency bins; and
expected heart rate bins are then be compared to noise bins and a threshold set.

18. The radar system of claim 17 wherein signal processing includes dynamic thresholding providing means for the radar to better adapt to various noise environments.

19. The radar system of claim 18 further comprising a set of diagnostic software that displays the raw radar output signal and is used to determine when and what problems exist.

20. The radar system of claim 19 wherein
the radar sensor requires a single, regulated 3.3 V power source capable of providing 500 mA;
sensitivity is set at 1.2 mV/cm2@1 Hz;
the near Doppler Passband is set at 0.1-7 Hz;
the far Doppler Passband is set at 7-160 Hz;
that Dynamic Range is set at 113 dB; and
Voltage is 3.6V at a Current of 18 mA.
